(19) United States
(12) Patent Application Publication
(10) Pub. No.: US 2018/0235200 A1
(43) Pub. Date: Aug. 23, 2018

(54) FISHING APPARATUS

(71) Applicant: William E. Coyle, JR., Houma, LA (US)

(72) Inventor: William E. Coyle, JR., Houma, LA (US)

(21) Appl. No.: 15/438,875

(22) Filed: Feb. 22, 2017

(51) Int. Cl. A01K 97/24

(52) U.S. Cl. CPC A01K 97/24

(57) ABSTRACT

A generally elongate fishing apparatus having an aperture and a slot of sufficient width to allow a fishing line introduced into the slot to enter the aperture, the fishing apparatus further including a necked portion adjacent to a distal end that is adjacent to the aperture. A fisherman can avoid unwanted discomfort by introducing a fishing line into the aperture through the slot, wrapping the fishing line around the necked portion and by then gripping and pulling a handle portion of the fishing apparatus to pull tension into the fishing line to, for example, pull the fishing line free of an underwater obstruction or debris or to pull a fish captured on a hook on and end of the fishing line towards a boat, pier or dock and within a sufficient proximity for the fisherman to use a net to lift the fish from the water.

### BACKGROUND

### Field of the Invention

The present invention relates to tools used for handling very slender tensile cords such as, for example, fishing line used for angling.

### Background of the Related Art

Fishermen have long grappled with the problem of fishing line getting hung up on obstructions on the floor of a body of water. Fishermen know that the fishing line can often be freed of the obstruction by pulling the fishing line into tension and applying force through the fishing line to the obstruction. Often, a limb or branch from a tree or other naturally occurring obstacle can snag fishing lines and prevent the fisherman from easily reeling in his line onto a reel. Modern fishing lines are often comprised of nylon, polyvinylidene fluoride, polyethylene or other materials that can sustain very high loads using a very slender fishing line. These types of fishing line can, if pulled hard enough using an unprotected hand, cut the fingers severely. These types of fishing line can also damage a fishing rod or pull the eyes off the fishing rod if the rod is used pull the fishing line. Often, a fisherman may be forced to cut the fishing line and thereby sacrifice a leader, fishing hook, lead weights and other fishing accessories that may be installed on a portion of the fishing line that remains in the water after a fishing line is cut.

### BRIEF SUMMARY

One embodiment of the present invention provides an apparatus that can be used to prevent unwanted cuts or damage to a fisherman's hand resulting from pulling on a fishing line. Embodiments of the present invention provide an apparatus that is easy to use and that will enable a fisherman to quickly engage and disengage the apparatus with a fishing line to permit pulling the fishing line with the hand and without cutting the fingers or otherwise causing discomfort. Embodiments of the apparatus may be fabricated from materials that will cause the apparatus float if dropped in the water.

### BRIEF DESCRIPTION OF THE SEVERAL VIEWS OF THE DRAWINGS

FIG. 1 is a perspective view of a human hand having a length of fishing line wrapped around the fingers to prevent slippage of the fishing line as the hand pulls tension in the fishing line.

FIG. 2 is an elevation view of an embodiment of the fishing apparatus of the present invention.

FIG. 3 is a perspective view of the fishing apparatus of FIG. 1 as a portion of a fishing line is introduced through the slot into the aperture in the fishing apparatus.

FIG. 4 is the perspective view of FIG. 3 as the portion of the fishing line is wrapped around the distal portion of the fishing apparatus by one hand as the handle portion of the apparatus is gripped using the other hand.

FIG. 5 is the perspective view of FIG. 4 illustrating how the portion of the fishing line is wrapped around a distal portion of the fishing apparatus a plurality of times to secure the portion of the fishing line to the fishing apparatus.

FIG. 6 the perspective view of FIG. 5 illustrating how the fishing apparatus can be used to pull tension in the fishing line without injuring or cutting the fisherman's hand.

### DETAILED DESCRIPTION

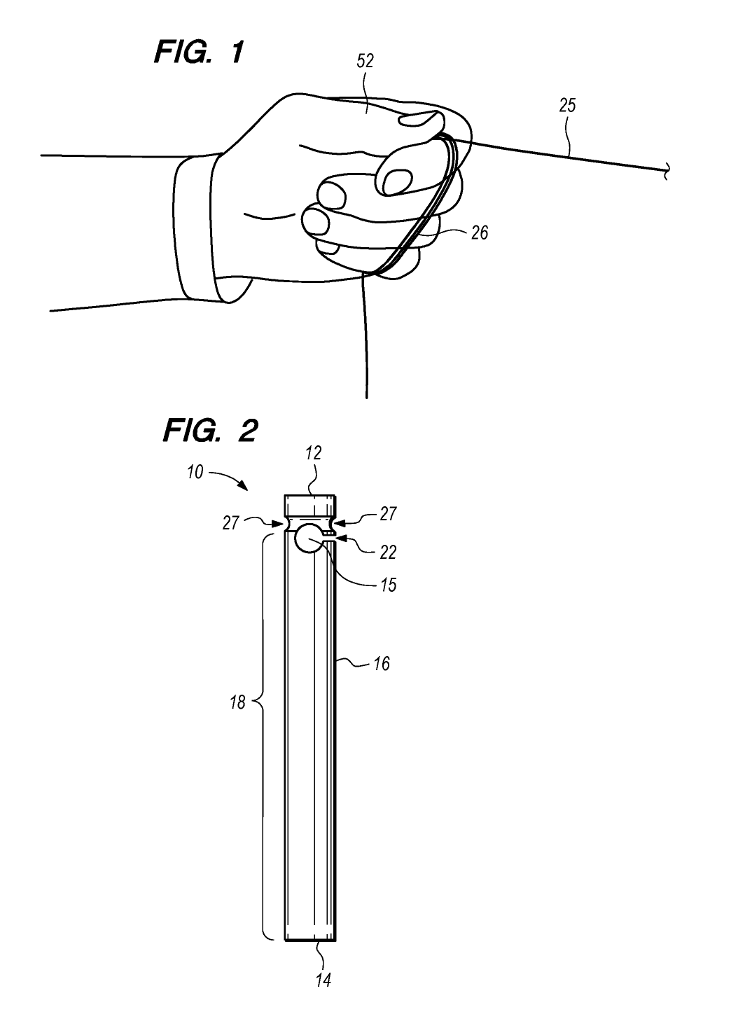

FIG. 1 is a perspective view of a human hand having a portion of a fishing line wrapped around the fingers of a human hand to prevent unwanted slippage of the fishing line as the hand pulls tension in the fishing line. The fishing line is very slender and can cut or cause discomfort to a human hand if pulled as shown in FIG. 1.

FIG. 2 is an elevation view of an embodiment of the fishing apparatus 10 of the present invention. The embodiment of the fishing apparatus 10 of FIG. 2 includes a distal end 12 and a proximal end 14, a handle portion 18, an aperture 15, a slot 22, a necked portion 27 adjacent to the slot 22 and an exterior surface 16.

FIG. 3 is a perspective view of the embodiment of the fishing apparatus 10 of FIG. 1 as a fishing line 25 is introduced through the slot 22 into the aperture 15 in the fishing apparatus 10. This is the initial step in engaging the fishing line 25 with the fishing apparatus 10.

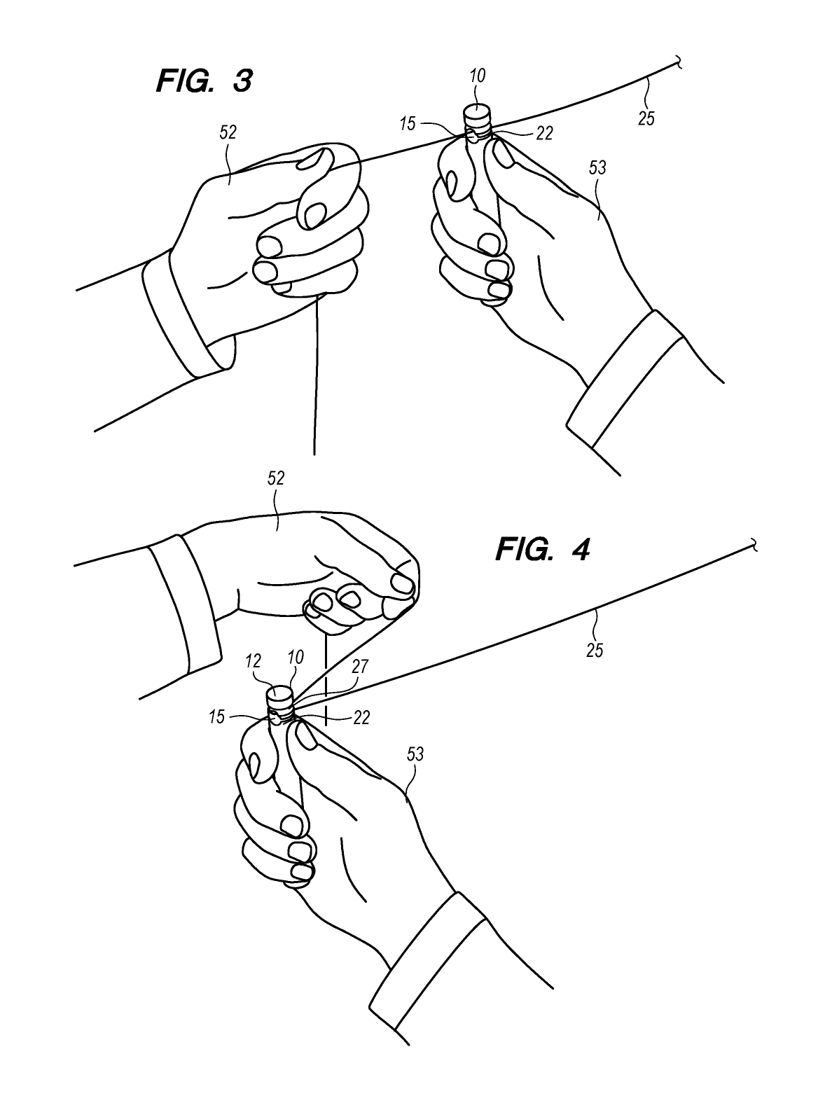

FIG. 4 is the perspective view of FIG. 3 as the fishing line 25 is wrapped around the fishing apparatus 10 adjacent to the distal end 12 of the fishing apparatus 10 by one hand 52 as the handle portion 18 of the apparatus 10 is gripped using the other hand 53. Preferably, the fishing line 25 is wrapped around the necked portion 27 of the fishing apparatus 10 adjacent to the distal end 12 of the fishing apparatus 10.

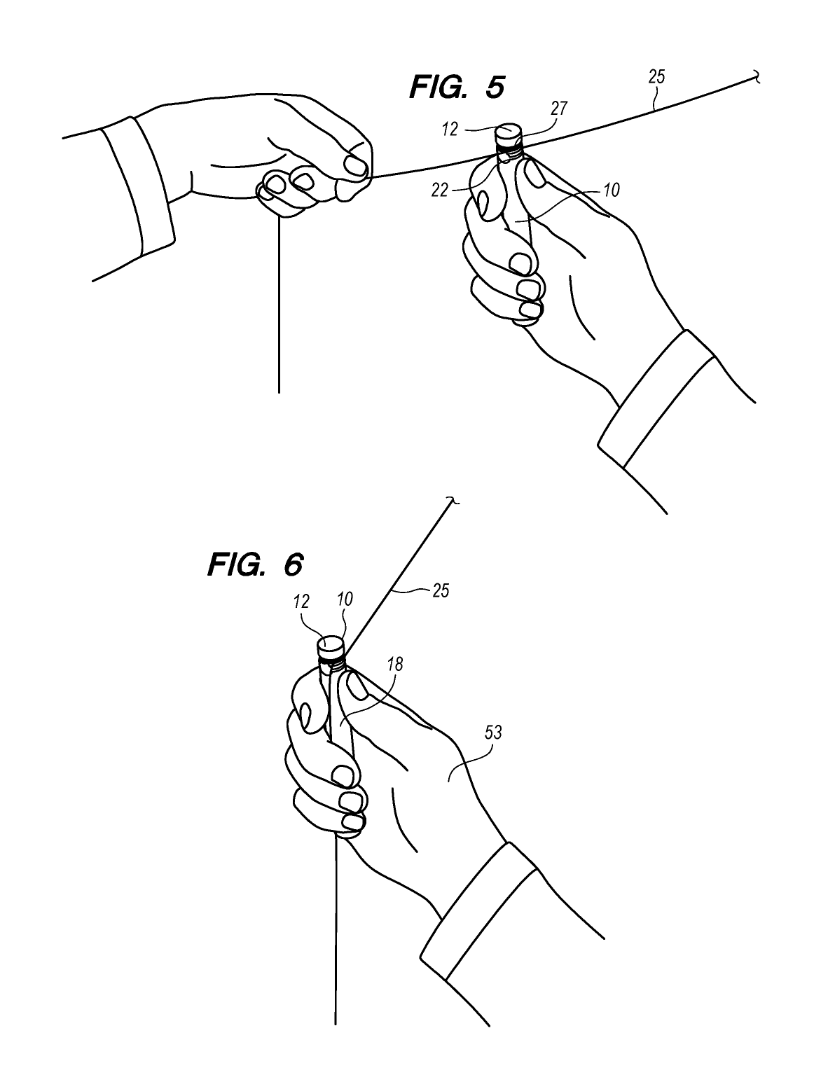

FIG. 5 is the perspective view of FIG. 4 illustrating how the fishing line 25 is wrapped around the fishing apparatus 10 adjacent to the distal end 12 of the fishing apparatus 10 a plurality of times after being received into the slot 22 to secure the fishing line 25 to the fishing apparatus 10. The fishing line 25 is shown to have been wrapped around the necked portion 27 of the fishing apparatus 10.

FIG. 6 the perspective view of FIG. 5 illustrating how the fishing apparatus 10 can be gripped at the handle portion 18 by the fisherman's hand 53 and used to pull tension in the fishing line 25 without injuring or cutting the fisherman's hand 53.

It will be understood that, in addition to the necked portion 27 of the apparatus 10, the fishing line 25 can also be wrapped or wound around the handle portion 18, which is larger around than the necked portion 27 and also larger around than the narrow portion between the necked portion 27 and the handle portion 18 and adjacent to the aperture 15. This enables more of the fishing line 25 to be gathered in each wrap or winding, and the handle portion 18 is substantially more robust and resistant to breaking than the necked portion 27 or the narrow portion between the necked portion 27 and the handle portion 18 and adjacent to the aperture 15.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An apparatus, comprising:
a handle portion;
a distal end;
an aperture proximal to the distal end; and
a slot extending from an exterior surface of the fishing apparatus to the aperture, the slot being of sufficient width to allow a fishing line to pass therethrough to the aperture;
wherein a portion of a fishing line can be introduced through the slot and into the aperture and then wrapped around the fishing apparatus a plurality of times to secure the fishing apparatus to the fishing line; and
wherein a user can grip the handle portion and pull tension in the fishing line and thereby prevent discomfort to a fisherman's hand caused by pulling on the fishing line with an unprotected hand.

2. The apparatus of claim 1, wherein the distal end is generally cylindrical in shape.

3. The apparatus of claim 2, wherein the handle portion is generally cylindrical in shape.

4. The apparatus of claim 3, further comprising:
a necked portion disposed about a circumference of the fishing apparatus proximal to the distal end and adjacent to the slot;
wherein the necked portion may be used for wrapping the fishing line within the necked portion.
